(19) United States
(12) Patent Application Publication
(10) Pub. No.: US 2013/0181888 A1
(43) Pub. Date: Jul. 18, 2013

(54) HEAD-MOUNTED DISPLAY

(71) Applicant: SONY CORPORATION, Tokyo (JP)

(72) Inventors: Shinobu Kuriya, Kanagawa (JP); Masatoshi Ueno, Kanagawa (JP); Kenichi Kabasawa, Saitama (JP); Daisuke Kawakami, Kanagawa (JP); Tetsuro Goto, Tokyo (JP); Hisako Sugano, Kanagawa (JP); Tsubasa Tsukahara, Tokyo (JP); Toshiyuki Nakagawa, Kanagawa (JP); Hirotaka Ishikawa, Kanagawa (JP)

(73) Assignee: SONY CORPORATION, Tokyo (JP)

(21) Appl. No.: 13/717,206

(22) Filed: Dec. 17, 2012

(30) Foreign Application Priority Data
Jan. 18, 2012 (JP) 2012-008245

(51) Int. Cl. G02B 27/01

(52) U.S. Cl. CPC G02B 27/017
USPC 345/8

(57) ABSTRACT

A head-mounted display includes a display portion, a support portion, and an input operation unit. The display portion is configured to present an image to a user. The support portion is configured to support the display portion and be mountable on a head of the user. The input operation unit serves to control the image and includes a touch sensor provided to the display portion.

### CROSS REFERENCES TO RELATED APPLICATIONS

The present application claims priority to Japanese Priority Patent Application JP 2012-008245 filed in the Japan Patent Office on Jan. 18, 2012, the entire content of which is hereby incorporated by reference.

### BACKGROUND

The present disclosure relates to a head-mounted display (HMD).

An HMD that is mounted on the head of the user and capable of presenting an image to a user through a display or the like provided in front of the eyes is known. A control of a display image in the HMD is generally performed by a press operation with respect to a button provided to the HMD or a dedicated input apparatus or the like connected to the HMD (see Japanese Patent Application Laid-open No. 2008-070817).

### SUMMARY

In the case where the button and the like are provided to the HMD, an occupation area of the button and the like increases. This affects the design. Further, in this case, the types of operations are limited. On the other hand, in the case where an input operation is performed using the dedicated input apparatus or the like, it is necessary to carry both of the HMD and the input apparatus or the like, which is disadvantageous in terms of portability. Further, in this case, in addition to the HMD, for example, it is necessary to take out the input apparatus from a bag or the like. Therefore, it is sometimes difficult to smoothly perform an input operation.

In view of the above-mentioned circumstances, it is desirable to provide a head-mounted display that is excellent in operability and portability and capable of enhancing convenience during an input operation.

According to an embodiment of the present disclosure, there is provided a head-mounted display including a display portion, a support portion, and an input operation unit.

The display portion is configured to present an image to a user.

The support portion is configured to support the display portion and be mountable on a head of the user.

The input operation unit serves to control the image and includes a touch sensor provided to the display portion.

In the head-mounted display, the input operation unit includes the touch sensor, and hence an input operation having a high degree of freedom is made possible, which can enhance operability. Further, the input operation unit is provided to the display portion, and hence an input apparatus or the like separate from the HMD becomes unnecessary and it is possible to enhance portability and convenience during an input operation.

The input operation unit may be provided to the outer surface of the display portion.

With this, the input operation unit can be provided at a position easy for the user to perform an input operation.

Specifically, the display portion may include a casing, a display element that is provided within the casing and configured to form the image, and an optical member including a display surface configured to display the image.

With this configuration, it is possible to emit, to the optical member, image light generated by the display element, and to present an image to the user via the display surface.

In the case of this configuration, the input operation unit may be provided on the casing. Alternatively, the input operation unit may be provided to be opposed to the display surface.

The input operation unit is provided using the configuration of the display portion. With this, it is unnecessary to change the form of the display portion due to the provision of the input operation unit, and hence it is possible to keep the design of the head-mounted display.

The optical member may further include a deflection element configured to deflect image light, which is emitted from the display element in a first direction, in a second direction orthogonal to the first direction to be guided into the optical member.

With this, the optical member can guide the image light to the eyes of the user to present an image to the user.

In the case of this configuration, the input operation unit may be provided on the deflection element.

With this, the input operation unit can be provided using a surface formed in the optical member.

Specifically, the deflection element may include a hologram diffraction grating.

With this, it is possible to efficiently reflect each light beam of the image light in a predetermined wavelength range at an optimal diffraction angle.

The touch sensor may be detachably provided to the display portion.

With this, the user is allowed to also perform an input operation at hand and to select an input operation method depending on a situation.

As described above, according to the embodiments of the present disclosure, it is possible to provide a head-mounted display that is excellent in operability and portability and capable of enhancing convenience during an input operation.

These and other objects, features and advantages of the present disclosure will become more apparent in light of the following detailed description of best mode embodiments thereof, as illustrated in the accompanying drawings.

Additional features and advantages are described herein, and will be apparent from the following Detailed Description and the figures.

### BRIEF DESCRIPTION OF THE FIGURES

FIG. 1 is a schematic perspective view showing a head-mounted display according to a first embodiment of the present disclosure;

FIG. 2 is a block diagram showing an inner configuration of the head-mounted display according to the first embodiment of the present disclosure;

FIG. 3 is a schematic plan view showing a configuration of a display portion of the head-mounted display according to the first embodiment of the present disclosure;

FIG. 4 is a flowchart of an operation example of the head-mounted display (controller) according to the first embodiment of the present disclosure;

FIGS. 5A and 5B are views each explaining a typical operation example of the head-mounted display according to the first embodiment of the present disclosure, in which FIG. 5A shows an operation surface of a touch panel on which a user performs an input operation and FIG. 5B shows an operation image to be presented to the user;

FIG. 6 is a schematic perspective view showing a head-mounted display according to a second embodiment of the present disclosure;

FIG. 7 is a schematic perspective view showing a head-mounted display according to a third embodiment of the present disclosure; and

FIG. 8 is a schematic perspective view showing a head-mounted display according to a fourth embodiment of the present disclosure.

### DETAILED DESCRIPTION

Hereinafter, embodiments of the present disclosure will be described with reference to the drawings.

### First Embodiment

[Head-Mounted Display]

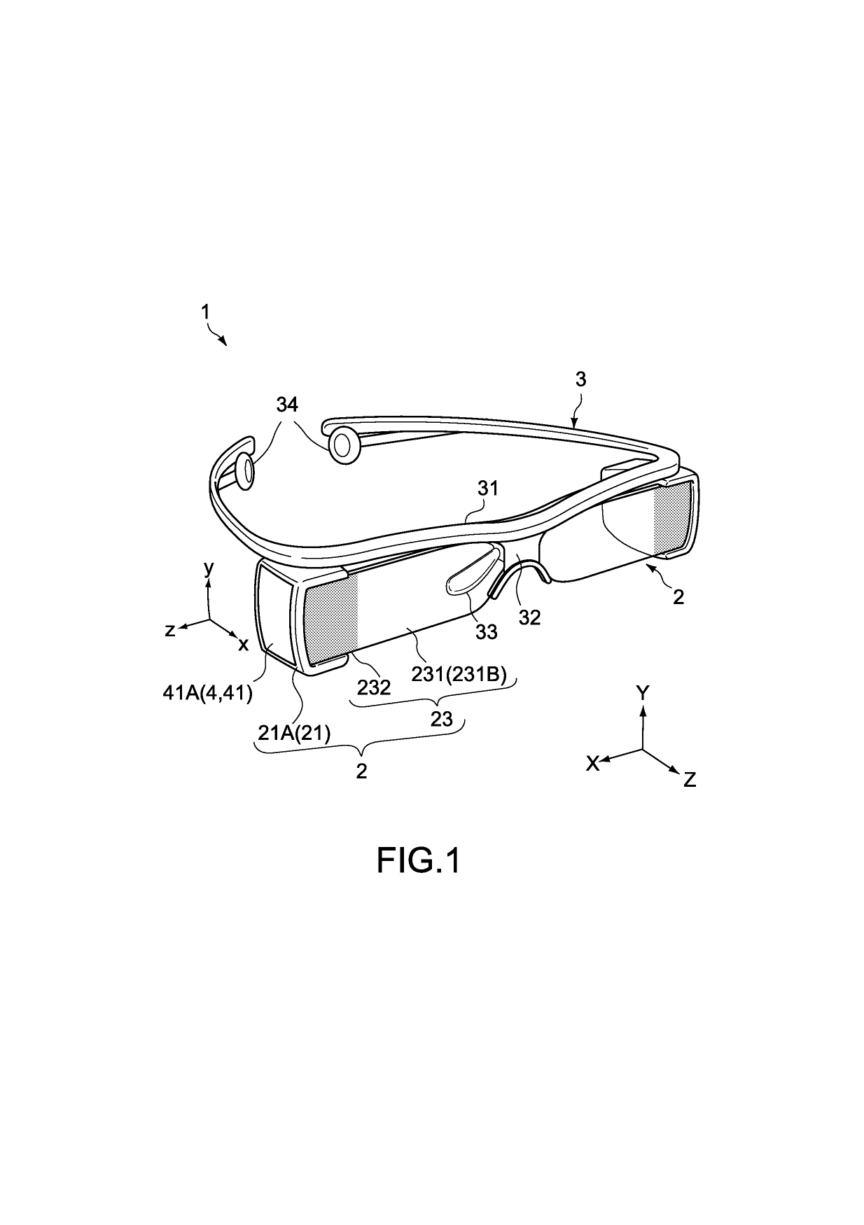

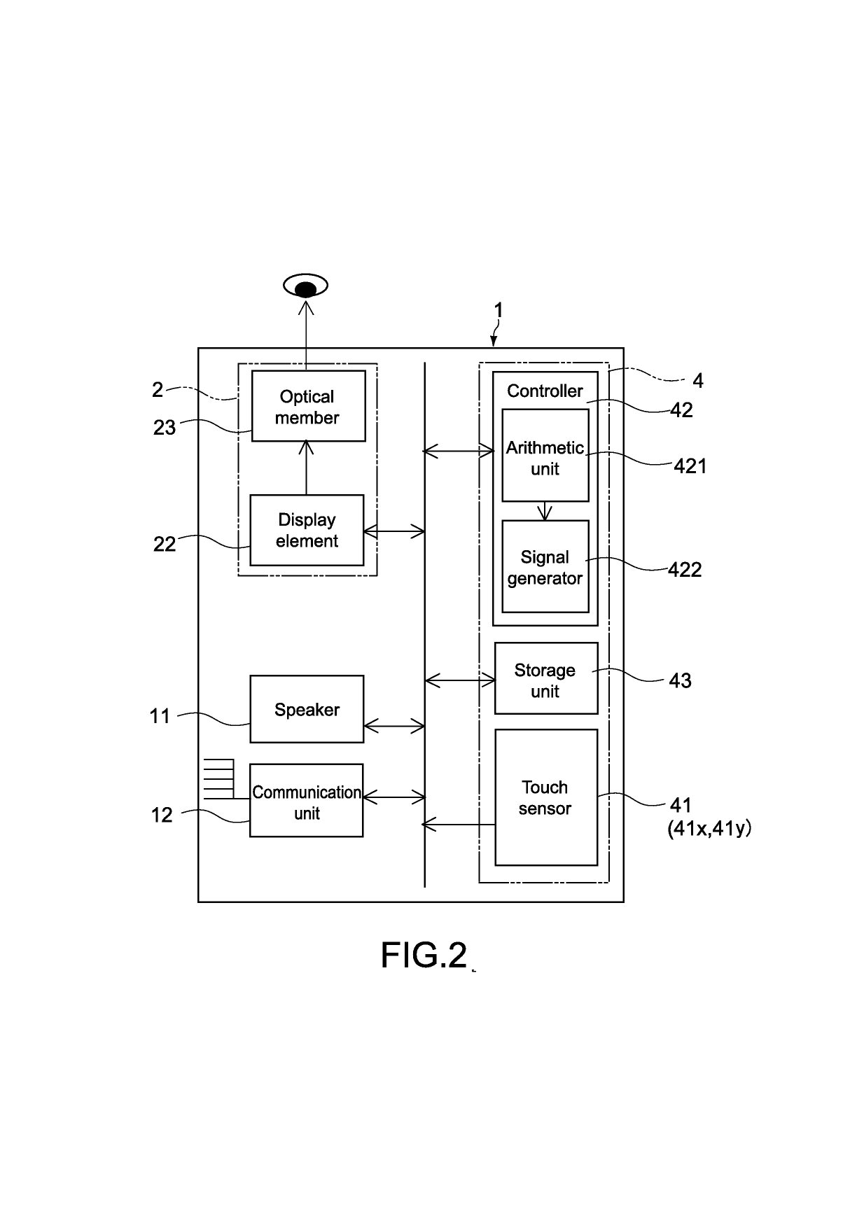

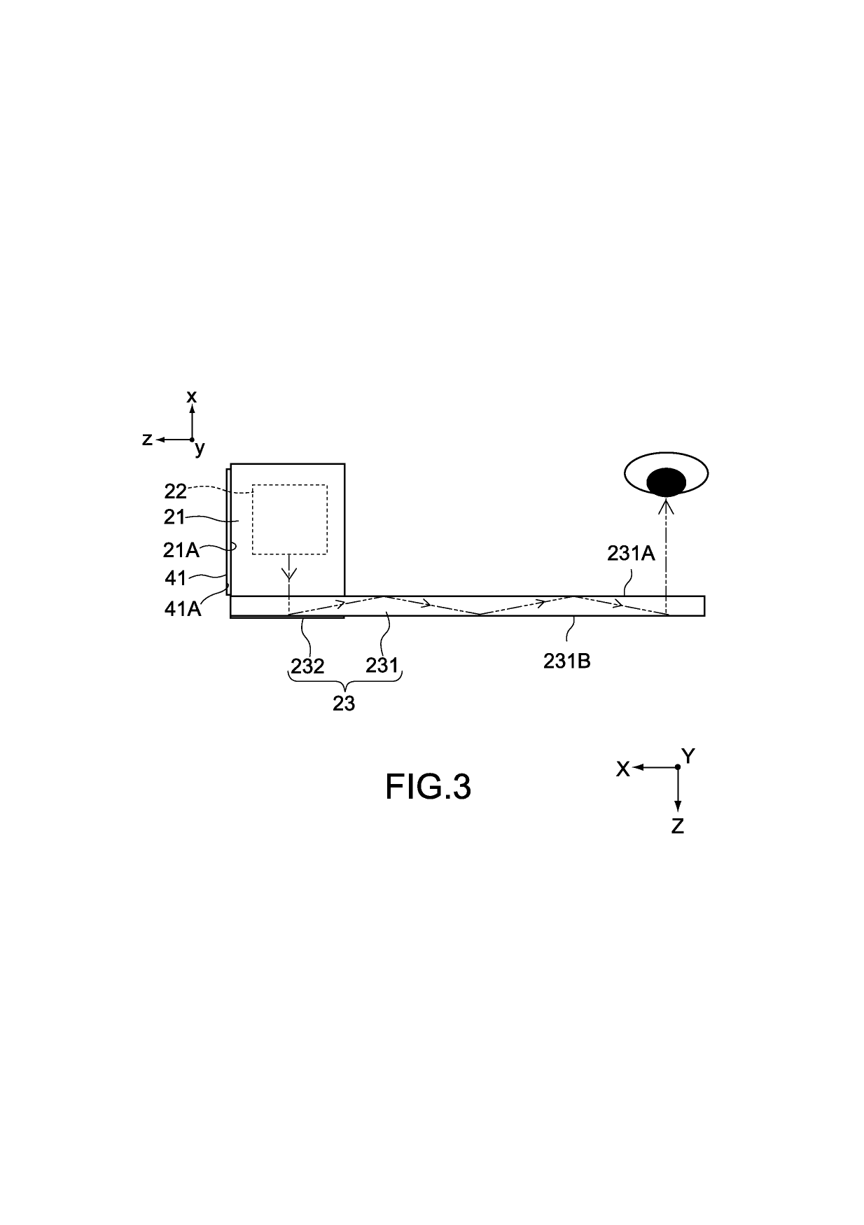

FIGS. 1, 2, and 3 are schematic views each showing a head-mounted display (HMD) 1 according to an embodiment of the present disclosure. FIG. 1 is a perspective view. FIG. 2 is a block diagram showing an inner configuration. FIG. 3 is a main-part plan view. The HMD 1 according to this embodiment includes display portions 2, a support portion 3, and an input operation unit 4. Note that, an X-axis direction and a Y-axis direction in the figures indicate directions almost orthogonal to each other, and show directions that are each parallel to a display surface on which an image is displayed to a user in this embodiment. The Z-axis direction indicates a direction orthogonal to the X-axis direction and the Y-axis direction.

In this embodiment, the HMD 1 is configured as a see-through HMD. The HMD 1 is shaped like glasses as a whole. The HMD 1 is configured to be capable of presenting images based on information inputted from the input operation unit 4 to a user while the user who puts the HMD 1 on the head is viewing an outside.

Note that, as will be described later, the HMD 1 includes two display portions 2 configured corresponding to left and right eyes. Those display portions 2 have almost the same configuration. Thus, in the figures and the following description, the same components of the two display portions 2 will be denoted by the same reference symbols.

[Support Portion]

The support portion 3 is configured to be mountable on the head of the user and to be capable of supporting an optical member 23 and a casing 21 of each of the display portions 2, which will be described later. Although a configuration of the support portion 3 is not particularly limited, a configuration example is shown in the following. The support portion 3 includes a main body 31 and a front portion 32. The main body 31 can be provided to be opposed to the face and the left and right temporal regions of the user. The front portion 32 is fixed to the main body 31 to be positioned at a center of the face of the user. The main body 31 is made of, for example, a synthetic resin or metal and is configured so that end portions placed on the left and right temporal regions are engageable to the ears of the user.

The main body 31 is configured to support the optical members 23 of the display portions 2 and the casings 21 fixed to the optical members 23. Upon mounting, the optical members 23 are arranged to be opposed to the left and right eyes of the user by the main body 31 and the front portion 32. That is, the optical members 23 are arranged like lenses of glasses. Upon mounting, the casings 21 are arranged to be opposed to vicinities of the temples of the user by the main body 31.

Further, the support portion 3 may include nose pads 33 fixed to the front portion 32. With this, it is possible to further improve wearing comfort of the user. Further, the support portion 3 may include earphones 34 movably attached to the main body 31. With this, the user is allowed to enjoy images with sounds.

[Input Operation Unit]

In this embodiment, the input operation unit 4 includes a touch sensor 41, a controller 42, and a storage unit 43. The input operation unit 4 controls an image to be presented to the user.

The touch sensor 41 includes an operation surface 41A that receives an input operation by a detection target. The touch sensor 41 is configured as a two-dimensional sensor having a panel shape. The touch sensor 41 detects a coordinate position corresponding to a movement of the detection target on an xy-plane, which is held in contact with the operation surface 41A, and outputs a detection signal corresponding to that coordinate position. In this embodiment, the touch sensor 41 is provided to an outer surface 21A of the casing 21 placed on a right-hand side of the user upon mounting.

The touch sensor 41 belongs to a two-dimensional coordinate system including an x-axis direction and a y-axis direction orthogonal to the x-axis direction, for example. The touch sensor 41 obtains a movement direction, movement speed, an amount of movement, and the like of a finger on the operation surface 41A. The z-axis direction in the figures indicates a direction almost orthogonal to the x-axis direction and the y-axis direction. Note that, the x-axis direction, the y-axis direction, and the z-axis direction correspond to the Z-axis direction, the Y-axis direction, and the X-axis direction, respectively.

The size and shape of the touch sensor 41 can be appropriately set depending on the size and shape of the outer surface 21A of the casing 21. In this embodiment, the touch sensor 41 is formed in an almost rectangular shape having a length about 2 to 3 cm in the x-axis direction and about 3 to 4 cm in the y-axis direction. The touch sensor 41 may be provided to be curved along the outer surface 21A as shown in FIG. 1. As a material of the operation surface 41A, for example, a non-transmissive material such as a synthetic resin or a transmissive material such as a transparent plastic plate, a glass plate, and a ceramic plate made of a polycarbonate resin, a polyethylene terephthalate (PET), or the like are employed.

In this embodiment, for the touch sensor 41, a capacitive touch panel capable of electrostatically detecting the detection target held in contact with the operation surface 41A is used. The capacitive touch panel may be a projected capacitive type or a surface capacitive type. The touch sensor 41 of this kind typically includes a first sensor 41x and a second sensor 41y. The first sensor 41x includes a plurality of first wirings that are parallel to the y-axis direction and arranged in the x-axis direction, and serves to detect an x-position. The second sensor 41y includes a plurality of second wirings that are parallel to the x-axis direction and arranged in the y-axis direction, and serves to detect a y-position. The first sensor 41x and the second sensor 41y are arranged to be opposed to each other in the z-axis direction. The touch sensor 41 is sequentially provided with a driving current for the first and second wirings by, for example, a driving circuit of the controller 42, which will be described later.

There are no particular limitations on the touch sensor 41. Other than the above, various sensors such as a resistive film sensor, an infrared sensor, a ultrasonic sensor, a surface acoustic wave sensor, an acoustic pulse recognition sensor, and an infrared image sensor may be applied as the touch sensor 41 as long as it is a sensor capable of detecting a coordinate position of the detection target. Further, the detection target is not limited to the finger of the user and may be a stylus or the like.

The controller 42 is typically constituted of a central processing unit (CPU) or a micro-processing unit (MPU). In this embodiment, the controller 42 includes an arithmetic unit 421 and a signal generator 422. Various functions are executed according to a program stored in the storage unit 43. The arithmetic unit 421 executes predetermined arithmetic processing on an electrical signal outputted from the touch sensor 41 and generates an operation signal including information on a relative position of the detection target held in contact with the operation surface 41A. Based on the arithmetic result, the signal generator 422 generates an image control signal for displaying an image on the display element 22. Further, the controller 42 includes a driving circuit for driving the touch sensor 41. In this embodiment, the driving circuit is incorporated in the arithmetic unit 421.

Specifically, based on a signal outputted from the touch sensor 41, the arithmetic unit 421 calculates an xy-coordinate position of the finger on the operation surface 41A. Further, by calculating a difference between the current xy-coordinate position and an xy-coordinate position detected a predetermined time ago, a change of the xy-coordinate position over time is calculated. In addition, in this embodiment, when continuous contact and non-contact operations within a predetermined period of time on a predetermined xy-coordinate position (hereinafter, referred to as “tap operation”) is detected, the arithmetic unit 421 executes particular processing assigned to a graphical user interface (GUI) (indicated item) corresponding to that coordinate position, which is shown in an image to be presented to the user. The processing result by the arithmetic unit 421 is transmitted to the signal generator 422.

Based on the processing result transmitted from the arithmetic unit 421, the signal generator 422 generates an image control signal to be outputted to the display element 22. According to the image control signal, for example, an image in which a pointer or the like corresponding to the xy-coordinate position on the operation surface 41A is overlapped on a menu selection image or the like in which the GUI and the like are shown may be generated. Further, an image in which a display mode (size, color tone, brightness, etc.) of a GUI selected by a tap operation or the like is changed may be generated.

The image control signal generated by the signal generator 422 is outputted to the two display elements 22. Further, the signal generator 422 may generate image control signals corresponding to the left and right eyes. With this, it is possible to present a three-dimensional image to the user.

Further, although not shown in the figures, the HMD 1 includes an A/D converter that converts a detection signal (analog signal) outputted from the touch sensor 41 into a digital signal and a D/A converter that converts a digital signal into an analog signal.

The storage unit 43 is constituted of a random access memory (RAM), a read only memory (ROM), another semiconductor memory, and the like. The storage unit 43 stores a calculated xy-coordinate position of the detection target, a program to be used for various calculations by the controller 42, and the like. For example, the ROM is constituted of a non-volatile memory and stores a program and a setting value for the controller 42 executing arithmetic processing such as calculation of the xy-coordinate position. Further, for example, a non-volatile semiconductor memory allows the storage unit 43 to store programs or the like for executing functions assigned to them. In addition, the programs stored in the semiconductor memory and the like in advance may be loaded into the RAM and may be executed by the arithmetic unit 421 of the controller 42.

Note that, the controller 42 and the storage unit 43 may be housed in, for example, the casing 21 of the HMD 1 or may be housed in different casings. In the case where the controller 42 and the storage unit 43 are housed in the different casings, the controller 42 is configured to be connectable to the touch sensor 41, the display portions 2, and the like in a wired or wireless manner.

[Display Portion]

FIG. 3 is a plan view schematically showing a configuration of the display portion 2. The display portion 2 includes the casing 21, the display element 22, and the optical member 23, and is configured to present an image to the user.

In the display portion 2, the display element 22 housed in the casing 21 forms an image and image light of that image is guided into the optical member 23 and emitted to the eye of the user. Further, the display portion 2 is provided with the touch sensor 41 of the input operation unit 4. In this embodiment, the touch sensor 41 is provided to, for example, the outer surface 21A of the casing 21.

The casing 21 houses the display element 22 and is formed in an almost cuboid shape in appearance in this embodiment. The casing 21 includes the outer surface 21A provided on, for example, a side not coming close to the user upon mounting, the outer surface 21A being orthogonal to the Z-axis direction. Although the outer surface 21A is a curved surface in this embodiment, the outer surface 21A may be a flat surface. Further, as described above, the touch sensor 41 is provided to the outer surface 21A in this embodiment.

The material of the casing 21 is not particularly limited and a synthetic resin, metal, or the like may be employed. The size of the casing 21 is not particularly limited as long as the casing 21 can house the display element 22 and the like without interfering with mounting of the HMD 1.

In this embodiment, the display element 22 is constituted of, for example, a liquid-crystal display (LCD) element. The display element 22 has a plurality of pixels arranged in a matrix form. The display element 22 modulates light inputted from a light source (not shown) including light-emitting diodes (LEDs) and the like for each pixel according to an image control signal generated by the signal generator 422 and emits light that forms an image to be presented to the user. For the display element 22, for example, a three-charge coupled device (CCD) method in which image light beams corresponding to red (R), green (G), and blue (B) colors are individually emitted or a single-CCD method in which image light beams corresponding to those colors are emitted at the same time may be used.

The display element 22 is configured to emit, for example, image light in the Z-axis direction (first direction). Further, if necessary, by providing an optical system such as a lens, it is also possible to emit image light from the display element 22 to the optical member 23 in a desired direction.

In this embodiment, the optical member 23 includes a light guide plate 231 and a deflection element (hologram diffraction grating) 232 and is attached to be opposed to the casing 21 in the Z-axis direction.

The light guide plate 231 presents an image to the user via a display surface 231A from which the image light is emitted. For example, the light guide plate 231 is translucent and formed in a plate shape, including the display surface 231A having an XY-plane almost orthogonal to the Z-axis direction and an outer surface 231B opposed to the display surface 231A. Upon mounting, the light guide plates 231 are arranged in front of the eyes of the user like lenses of glasses, for example. The material of the light guide plate 231 may be appropriately employed in view of reflectivity and the like. For example, a transmissive material such as a transparent plastic plate, a glass plate, and a ceramic plate made of a polycarbonate resin, a polyethylene terephthalate (PET), or the like is employed.

For example, the hologram diffraction grating 232 has a film-like structure made of a photopolymer material or the like and is provided on the outer surface 231B to be opposed to the casing 21 and the display element 22 in the Z-axis direction. Although the hologram diffraction grating 232 is formed as a non-transmissive type in this embodiment, the hologram diffraction grating 232 may be formed as a transmissive type.

The hologram diffraction grating 232 is capable of efficiently reflecting light in a particular wavelength range at an optimal diffraction angle. For example, the hologram diffraction grating 232 is configured to diffract and reflect light in a particular wavelength range, which is emitted from the Z-axis direction, in the second direction so as to be totally reflected within the light guide plate 231, and to cause the light to be emitted from the display surface 231A toward the eye of the user. As the particular wavelength range, specifically, wavelength ranges corresponding to the red (R), green (G), and blue (B) colors are selected. With this, image light beams corresponding to the colors that are emitted from the display element 22 propagate within the light guide plate 231 and emitted from the display surface 231A. When the image light beams of the colors enter the eye of the user, a predetermined image is presented to the user. Note that, in FIG. 2, for the sake of convenience, only light in a single wavelength range is shown.

Further, at a position on the outer surface 231B that is opposed to the eye of the user, a hologram diffraction grating different from the hologram diffraction grating 232 may also be provided. With this, it becomes easy to emit the image light from the display surface 231A toward the eye of the user. In this case, by setting the hologram diffraction grating to be a transmissive hologram diffraction grating, for example, the configuration as the see-through HMD can be kept.

In addition, the HMD 1 includes a speaker 11. The speaker 11 converts an electrical audio signal generated by the controller 42 or the like into physical vibrations and provides audio to the user via the earphones 34. Note that, the configuration of the speaker 11 is not particularly limited.

Further, the HMD 1 may include a communication unit 12. With this, an image to be presented by the HMD 1 to the user can be obtained from the Internet or the like via the communication unit 12.

Note that, the casing 21 may be configured to be capable of housing, in addition to the display element 22, the controller 42 and the storage unit 43 or the speaker 11 and the communication unit 12, for example.

[Operation Example of HMD]

Next, a basic operation example of the HMD 1 will be described.

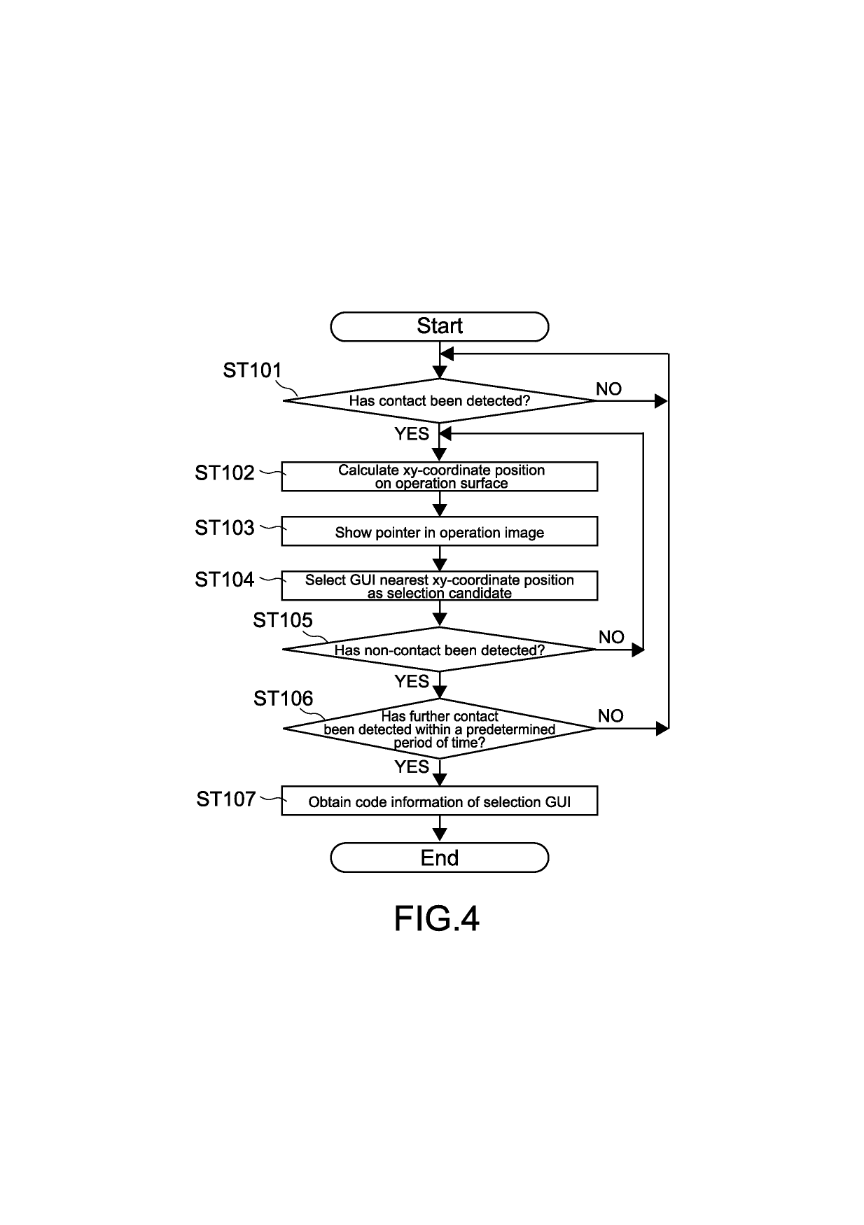

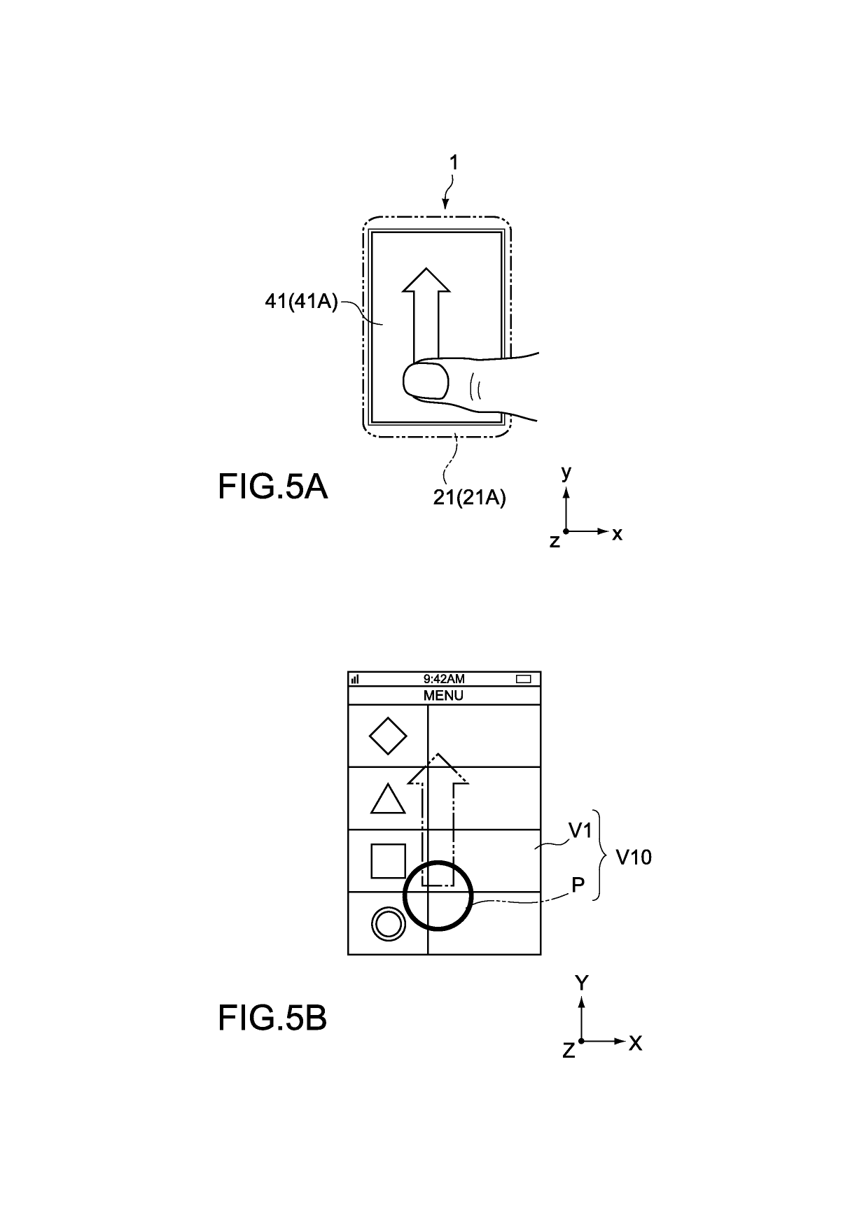

FIG. 4 is a flowchart of an operation example of the HMD 1 (controller 42). FIGS. 5A and 5B are views each explaining a typical operation example of the HMD 1. FIG. 5A shows the operation surface 41A on the casing 21, on which the user is performing an input operation. FIG. 5B shows an operation image to be presented to the user via the display surface 231A of the optical member 23. Here, an operation example of the HMD 1 when a tap operation is performed at a predetermined position on the operation surface 41A with the user wearing the HMD 1 is shown.

To the user wearing the activated HMD 1, via the display surface 231A, for example, an image V1 in which a number of GUIs are shown is displayed (see FIG. 5B). The image V1 is, for example, a menu selection image of various settings of the HMD 1. The GUIs each correspond to a shift of the HMD 1 to a mute mode, volume control, image reproduction, fast-forward, or a change of a pointer display mode, and the like. That is, by the user selecting a particular GUI, the input operation unit 4 is configured to be capable of changing settings of the HMD 1.

The touch sensor 41 outputs to the controller 42 a detection signal for detecting contact of the finger (detection target) of the user on the operation surface 41A. The arithmetic unit 421 of the controller 42 determines a contact state according to the detection signal (Step ST101).

When detecting the contact (YES in Step ST101), the arithmetic unit 421 of the controller 42 calculates the xy-coordinate position of the finger on the operation surface 41A based on the detection signal (Step ST102). An operation signal relating to the xy-coordinate position calculated by the arithmetic unit 421 is outputted to the signal generator 422.

Based on the operation signal and an image signal of the image V1, the signal generator 422 of the controller 42 generates a signal for controlling an operation image V10 in which a pointer P indicating a position of the detection target is overlapped on the image V1. The image signal of the image V1 may be stored in the storage unit 43 in advance. When this image control signal is outputted to the display element 22, the display element 22 emits image light of the operation image V10 to the optical member 23.

The optical member 23 guides the image light and causes the image light to be emitted from the display surface 231A of the light guide plate 231, to thereby present the operation image V10 to the user (Step ST103, FIG. 5B).

Further, when the finger of the user moves on the operation surface 41A, information on the xy-coordinate position changing over time is obtained by the touch sensor 41. The arithmetic unit 421 of the controller 42, which has obtained this information, calculates a change of the xy-coordinate position over time by calculating a difference between the current xy-coordinate position and an xy-coordinate position detected a predetermined time ago. Based on the result thereof, the signal generator 422 can output to the display element 22 a control signal for moving the pointer P. With this, corresponding to a movement of the finger of the user, the HMD 1 can move the pointer P in a display area of the image V1. FIGS. 5A and 5B show a movement state of the pointer P when the finger is moved to an arrow direction along the y-axis direction.

The controller 42 selects a GUI (hereinafter, referred to as selection GUI) that is nearest the calculated xy-coordinate position, as a selection candidate (Step ST104). Correspondingly, the GUI being the selection candidate of the operation image V10 to be displayed by the HMD 1 may be changed in display mode such as frame color, chroma, and luminescence. By viewing the operation image V10 displayed by the HMD 1, the user can check the GUI being the selection candidate.

Based on an output from the touch sensor 41, the controller 42 determines a contact state between the operation surface 41A and the finger (Step ST105). When the controller 42 does not determine non-contact (NO in Step ST105), i.e., determines that the contact state is maintained, the controller 42 calculates an xy-coordinate position of the operation surface 41A and selects a selection candidate GUI again (Steps ST102 to 104).

On the other hand, when determining the non-contact (YES in Step ST105), the controller 42 determines further contact of the finger based on a signal from the touch sensor 41 (Step ST106). When detecting the further contact of the finger within a predetermined period of time (YES in Step ST106), i.e., when the user performs a tap operation on the selection candidate GUI, the controller 42 determines that this selection candidate GUI is the selection GUI. At this time, the controller 42 obtains code information corresponding to the selection GUI, which is stored in the storage unit 43 (Step ST107).

On the other hand, when not detecting the further contact within the predetermined period of time (NO in Step ST106), the controller 42 determines that the selection candidate GUI has not been selected. Then, the pointer P disappears from the operation image V10 of the HMD 1 and the display returns to the image V1.

In addition, based on the obtained code information, the controller 42 executes processing corresponding to the selection GUI. This processing is executed based on, for example, the programs or the like stored in the storage unit 43. For example, if a function corresponding to the selection GUI is a “shift to a mute mode,” the controller 42 can shift the settings of the HMD 1 to the mute mode by executing processing based on the code information corresponding to the GUI.

Otherwise, if the code information obtained in Step ST107 is, for example, volume control, the controller 42 may generate an image control signal based on the code information and may also output the image control signal to the display element 22. With this, to the user wearing the HMD 1, presented is, for example, a new operation image (not shown) on which a volume control bar or the like is overlapped. Otherwise, if the obtained code information is, for example, image reproduction, by the controller 42 generating an image control signal based on the code information, a thumbnail image or the like (not shown) for selecting video content to be reproduced is presented to the user.

As described above, the touch sensor 41 and the operation surface 41A are provided in the outer surface 21A of the casing 21, and hence the HMD 1 according to this embodiment does not need a dedicated input apparatus or the like. With this, for example, even if the HMD 1 is used at a place where it is difficult to take out the input apparatus or the like, for example, on a crowded train, an input operation can be performed on the HMD 1, which enhances convenience. In addition, it becomes easy to carry the HMD 1.

Further, the HMD 1 allows the touch sensor 41 to be provided without changing the entire size, mode, and the like, and hence it is possible to keep wearing comfort and portability of the user. Further, the HMD 1 can ensure a degree of freedom in apparatus design without largely affecting the design due to the provision of the touch sensor 41 and the like.

In addition, the HMD 1 employs the touch sensor 41 as the input operation unit 4, and hence an input operation having a higher degree of freedom is made possible in comparison with a button or the like, which can enhance operability. With this, the user is enabled to select a desired GUI even in, for example, a menu selection image in which a number of GUIs are shown.

Further, in this embodiment, the touch sensor 41 is provided to the outer surface 21A of the casing 21, and hence the user can easily perform an input operation without taking an unnatural posture.

### Second Embodiment

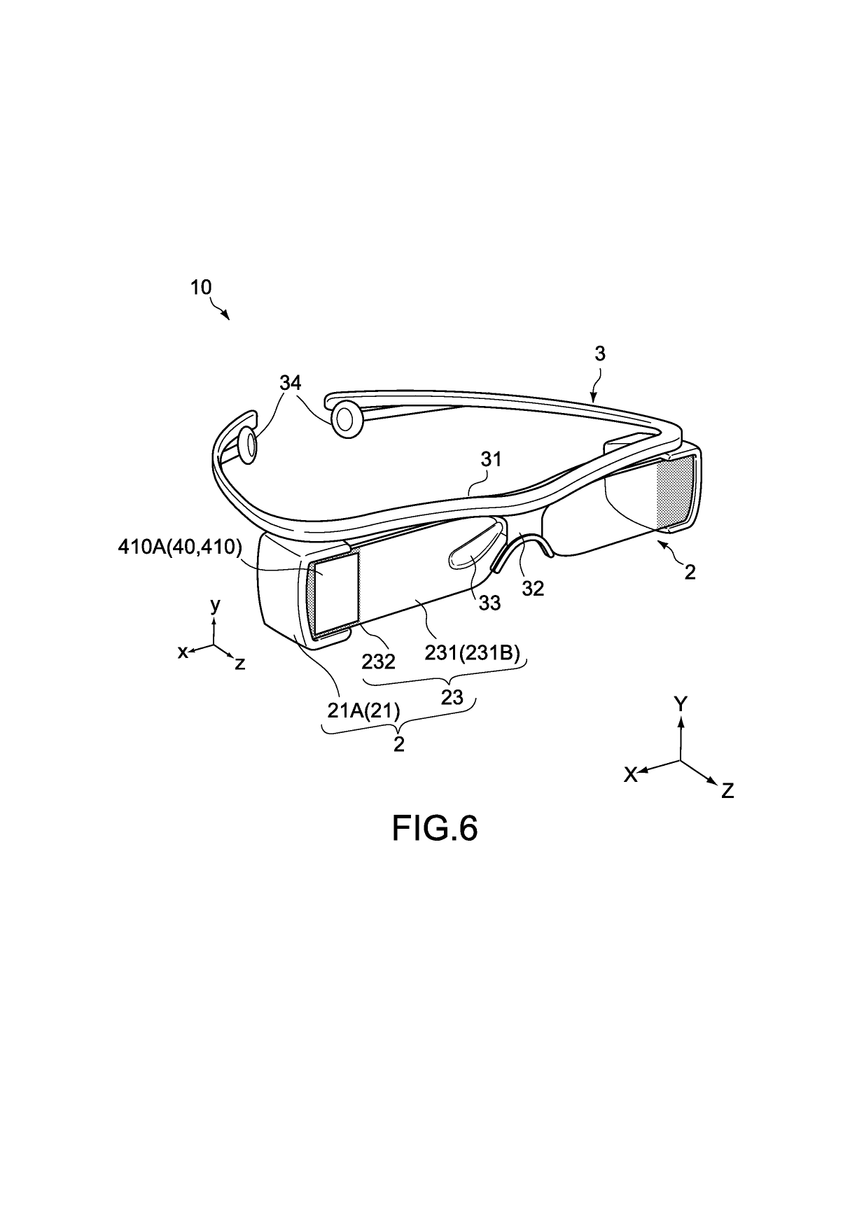

FIG. 6 is a perspective view schematically showing an HMD 10 according to a second embodiment of the present disclosure. In this embodiment, descriptions of the same configuration and action as in the first embodiment will be omitted or simplified, and parts different from the first embodiment will be mainly described.

The HMD 10 according to this embodiment is different from the first embodiment in that an operation surface 410A and a touch sensor 410 of an input operation unit 40 are provided on a hologram diffraction grating 232 of an optical member 23. The touch sensor 410 belongs to, for example, a two-dimensional coordinate system including an x-axis direction and a y-axis direction orthogonal to the x-axis direction. The x-axis direction, the y-axis direction, and a z-axis direction correspond to an X-axis direction, a Y-axis direction, and a Z-axis direction, respectively. That is, in this embodiment, an xy-plane to which the touch sensor 410 belongs and an XY-plane to which an image to be displayed to the user belongs are parallel to each other. With this, an operation direction and a movement direction of a pointer can correspond to each other, and hence it is possible to provide the user with operability that matches the intuition of the user.

Further, in this embodiment, the hologram diffraction grating 232 is provided on an almost flat light guide plate 231. With this, by providing the touch sensor 410 as described above, the touch sensor 410 can be provided on the almost flat surface, which can enhance operability. In addition, according to this embodiment, the same action and effect as in the first embodiment can be obtained.

### Third Embodiment

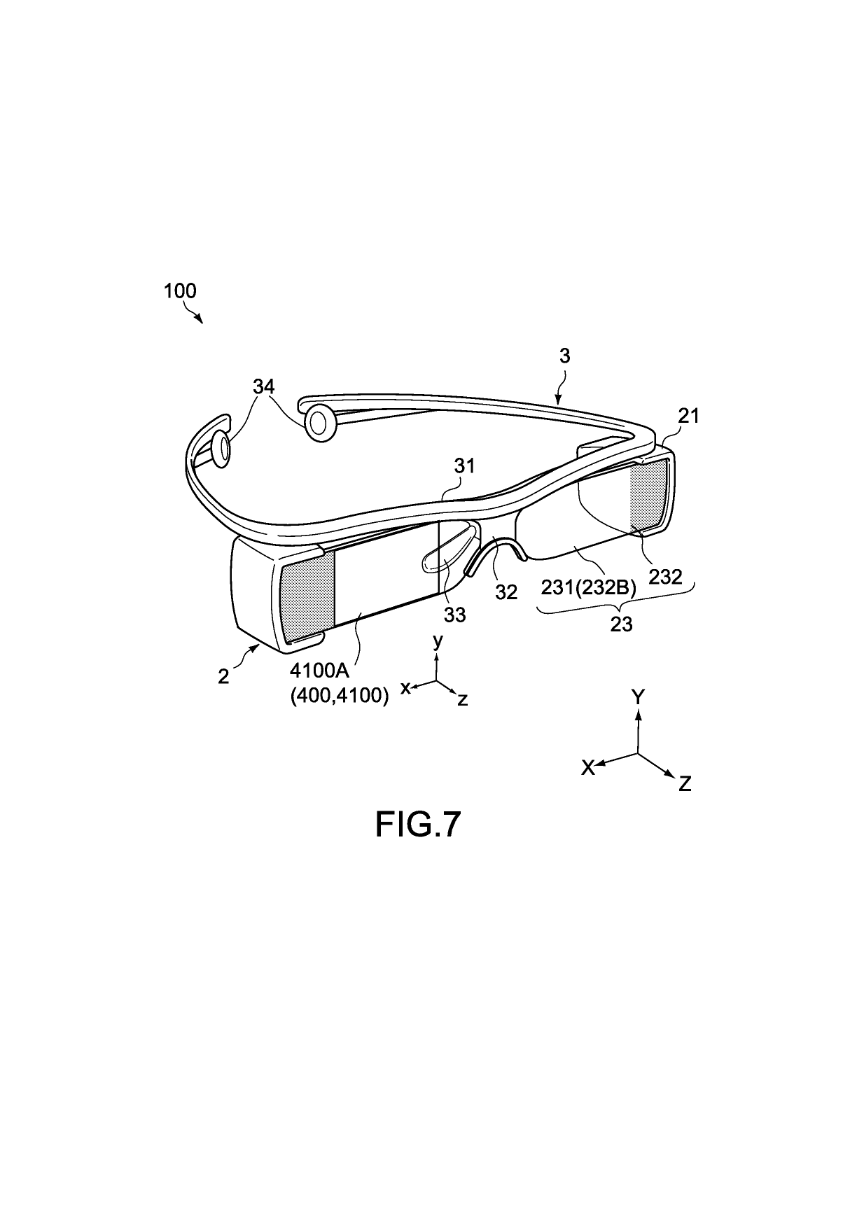

FIG. 7 is a perspective view schematically showing an HMD 100 according to a third embodiment of the present disclosure. In this embodiment, descriptions of the same configuration and action as in the first embodiment will be omitted or simplified, and parts different from the first embodiment will be mainly described.

The HMD 100 according to this embodiment is different from the first embodiment in that an operation surface 4100A and a touch sensor 4100 of an input operation unit 400 are provided on an outer surface 231B of an optical member 23, in which a hologram diffraction grating 232 is not provided. The touch sensor 4100 belongs to, for example, a two-dimensional system including an x-axis direction and a y-axis direction orthogonal to the x-axis direction. As in the second embodiment, the x-axis direction, the y-axis direction, and a z-axis direction correspond to an X-axis direction, a Y-axis direction, and a Z-axis direction, respectively. Thus, also with the HMD 100, it is possible to provide the user with operability that matches the intuition of the user.

Further, by providing the touch sensor 4100 as described above, the touch sensor 4100 can be provided on an almost flat surface, which can further enhance operability of the user. In addition, according to this embodiment, the same action and effect as in the first embodiment can be obtained.

In addition, by forming the operation surface 4100A of a transmissive material such as a transparent plastic plate, a glass plate, a ceramic plate made of a polycarbonate resin, a polyethylene terephthalate (PET), or the like, and by forming first and second sensors of, for example, a transparent electrode such as an ITO electrode, the touch sensor 4100 can be configured to have a transmissive property as a whole. With this, the HMD 100 according to this embodiment can be configured as the see-through HMD 100 even if the touch sensor 4100 is provided.

### Fourth Embodiment

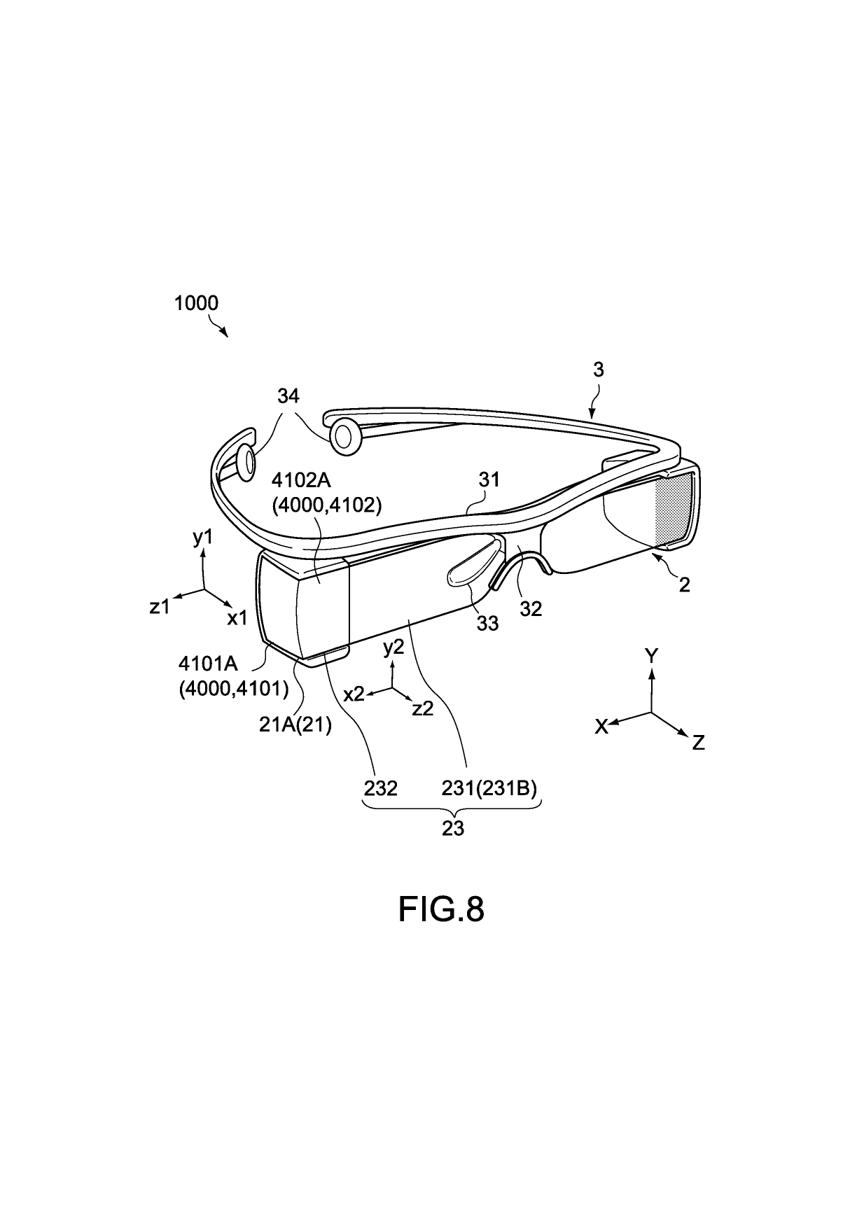

FIG. 8 is a perspective view schematically showing an HMD 1000 according to a fourth embodiment of the present disclosure. In this embodiment, descriptions of the same configuration and action as in the first embodiment will be omitted or simplified, and parts different from the first embodiment will be mainly described.

This embodiment is different from the first embodiment in that an input operation unit 4000 of the HMD 1000 includes a first touch sensor 4101 and a second touch sensor 4102. Specifically, the first touch sensor 4101 (first operation surface 4101A) is provided to an outer surface 21A of a casing 21 and the second touch sensor 4102 (second operation surface 4102A) is provided on a hologram diffraction grating 232 of an optical member 23.

The first touch sensor 4101 belongs to, for example, a two-dimensional coordinate system including an x1-axis direction and a y1-axis direction orthogonal to the x1-axis direction. The x1-axis direction, the y1-axis direction, and a z1-axis direction correspond to a Z-axis direction, a Y-axis direction, and an X-axis direction, respectively. The second touch sensor 4102 belongs to, for example, a two-dimensional coordinate system including an x2-axis direction and a y2-axis direction orthogonal to the x2-axis direction. The x2-axis direction, the y2-axis direction, and a z2-axis direction correspond to the X-axis direction, the Y-axis direction, and the Z-axis direction, respectively. That is, the first touch sensor 4101 and the second touch sensor 4102 are arranged in directions almost orthogonal to each other. The first touch sensor 4101 and the second touch sensor 4102 may be continuously arranged as shown in FIG. 8 or may be spaced from each other.

With this, by, for example, the user placing a thumb on the first operation surface 4101A and an index finger on the second operation surface 4102A and then changing an interval between the two fingers, it becomes easy to perform a so-called pinch-to-zoom operation. That is, according to the HMD 1000 having the above-mentioned configuration, various operations can be easily performed. Further, it is possible to ensure a larger area of the touch sensor, which can further enhance operability. In addition, according to this embodiment, the same action and effect as in the first and second embodiments can be obtained.

Although the embodiments of the present disclosure have been described above, the present disclosure is not limited thereto and various modifications can be made based on the technical concept of the present disclosure.

For example, the touch sensor may be detachably provided to the display portion. In this case, the touch sensor is configured to be capable of outputting a detection signal to the controller or the like, by, for example, a wired communication using a cable or the like or a wireless communication such as “Wi-Fi (registered trademark)” and “Bluetooth (registered trademark).” With this, the user is allowed to also select an input operation at hand and to select an input operation method depending on a situation.

Although, in each of the above-mentioned embodiments, the two display portions 2 are provided corresponding to the left and right eyes, the present disclosure is not limited thereto. For example, a single display portion may be provided corresponding to either one of the left and right eyes.

Further, although, in each of the above-mentioned embodiments, the hologram diffraction grating is used as the deflection element, the present disclosure is not limited thereto. For example, other diffraction gratings and a light reflecting film made of metal or the like may be employed. Further, although, in each of the above-mentioned embodiments, the deflection element is provided to the outer surface of the light guide plate, the deflection element may be provided inside the light guide plate.

Further, a CCD camera or the like may be provided to the front portion of the support portion so that the HMD can perform imaging. With this, the HMD can have functions of checking and editing captured images and the like according to an input operation via the touch sensor.

In each of the above embodiments, the see-through HMD has been described, the present disclosure is not limited thereto and is also applicable to a non-see-through HMD.

It should be noted that the present disclosure may also take the following configurations.
(1) A head-mounted display, including:
   a display portion configured to present an image to a user;
   a support portion configured to support the display portion and be mountable on a head of the user; and
   an input operation unit for controlling the image, the input operation unit including a touch sensor provided to the display portion.
(2) The head-mounted display according to (1), in which the input operation unit is provided to an outer surface of the display portion.
(3) The head-mounted display according to (1) or (2), in which
   the display portion includes
      a casing,
      a display element that is provided within the casing and configured to form the image, and
      an optical member including a display surface configured to display the image.
(4) The head-mounted display according to (3), in which
   the input operation unit is provided on the casing.
(5) The head-mounted display according to (3) or (4), in which
   the input operation unit is provided to be opposed to the display surface.
(6) The head-mounted display according to any one of (3) to (5), in which
   the optical member further includes a deflection element configured to deflect image light, which is emitted from the display element in a first direction, in a second direction orthogonal to the first direction to be guided into the optical member.
(7) The head-mounted display according to (6), in which
   the input operation unit is provided on the deflection element.
(8) The head-mounted display according to (6) or (7), in which
   the deflection element includes a hologram diffraction grating.
(9) The head-mounted display according to any one of (1) to (8), in which the touch sensor is detachably provided to the display portion.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A head-mounted display, comprising:
a display portion configured to present an image to a user;
a support portion configured to support the display portion and be mountable on a head of the user; and
an input operation unit for controlling the image, the input operation unit including a touch sensor provided to the display portion.

2. The head-mounted display according to claim 1, wherein
the input operation unit is provided to an outer surface of the display portion.

3. The head-mounted display according to claim 1, wherein
the display portion includes
a casing,
a display element that is provided within the casing and configured to form the image, and
an optical member including a display surface configured to display the image.

4. The head-mounted display according to claim 3, wherein
the input operation unit is provided on the casing.

5. The head-mounted display according to claim 3, wherein
the input operation unit is provided to be opposed to the display surface.

6. The head-mounted display according to claim 3, wherein
the optical member further includes a deflection element configured to deflect image light, which is emitted from the display element in a first direction, in a second direction orthogonal to the first direction to be guided into the optical member.

7. The head-mounted display according to claim 6, wherein
the input operation unit is provided on the deflection element.

8. The head-mounted display according to claim 6, wherein
the deflection element includes a hologram diffraction grating.

9. The head-mounted display according to claim 1, wherein
the touch sensor is detachably provided to the display portion.
